(19) United States
(12) Patent Application Publication
(10) Pub. No.: US 2004/0081424 A1
(43) Pub. Date: Apr. 29, 2004

(54) Transceiver integrated circuit and communication module

(75) Inventors: Shohei Moriwaki, Tokyo (JP); Yoshifumi Azekawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/431,461

(22) Filed: May 8, 2003

(30) Foreign Application Priority Data
Oct. 29, 2002 (JP) 2002-314242

(51) Int. Cl. G02B 6/00

(52) U.S. Cl. 385/147

(57) ABSTRACT

An optical communication module (10) comprises a transmitting laser (5), a receiving element (6), and a peripheral IC (2) for controlling the transmitting laser (5) and the receiving element (6). The peripheral IC (2) is connected to a transceiver IC (1) through a serial bus (4) for peripheral IC. The transceiver IC (1) of the optical communication module (10) is connected to a high-order layer circuit (21) through a serial bus (3) for high-order layer. The transceiver IC (1) comprises a register 15 for high-order layer including an NV register and a DOM register, and an additional register (16) including an LASI register and a VS register. Both the serial bus (3) for high-order layer and the serial bus (4) for peripheral IC are connected to the register (15) for high-order layer and the additional register (16).

### BACKGROUND OF THE INVENTION

1. Field of the Invention

The present invention relates to a transceiver provided to communication modules mutually connected through buses. For example, the present invention may be applied to a transceiver which conforms to the standard as laid down by the IEEE 802.3ae.

2. Description of the Background Art

The exemplary transceiver provided to communication modules mutually connected through buses is the one which conforms to the IEEE 802.3ae standard. As a serial bus to be employed by the IEEE 802.3ae, an MDIO (management data input/output) interface bus (hereinafter referred to as “MDIO bus”), an I²C (inter IC) bus (hereinafter referred to as “I²C bus”) introduced in the document 1 to be referred to later and the like, are applicable.

The configuration in compliance with the IEEE 802.3ae specification is introduced in the document 2 to be referred to later. The document 2 specifies registers which are provided to a transistor conforming to the IEEE 802.3ae standard. A transceiver IC for 10 Gb Ethernet® (transceiver integrated circuit; hereinafter simply referred to as “transceiver IC”) has been developed in conformity with the IEEE 802.3ae standard, and is provided with registers as follows included in “XENPAK Register Set” which is specified in the document 2: a non-volatile register (hereinafter referred to as “NV register”), a register for “digital optical monitoring” (hereinafter as “DOM register”), a register for “link alarm status interrupt” (hereinafter as “LASI register”), and a register for “vendor specific” (hereinafter as “VS register”).

A transceiver IC is connected to a high-order layer such as an MAC (media access control) layer for controlling a plurality of transceiver ICs through an MDIO bus as a high-order bus. Together with a transmitting laser and a peripheral IC (integrated circuit) for monitoring and controlling this laser, for example, the transceiver IC constitutes an optical communication module. The peripheral IC and the transceiver IC are connected through an I²C bus for peripheral IC.

[document 1] “THE I2C-BUS SPECIFICATION VERSION 2.1”. January 2000. Philips Semiconductor. <http://www-us.semiconductors.philips.com/acrobat/various/I2_BUS_SPECIFICATION_{—}3.pdf.>. (Accessed 17 Oct. 2002).

[document 2] “A Cooperation Agreement for 10 Gigabit Ethernet Transceiver Package Issue 3.0”. 1 8^{th} Sep. 2002. XENPAK. <http://www.xenpak.org/MSA/XENPAK_MSA_R3.0.pdf> (Accessed 17 Oct. 2002).

However, the peripheral IC has not been allowed to directly access the NV register and the DOM register. Therefore, these registers cannot immediately respond to information provided from the peripheral IC such as abnormality in the transmitting laser, whereby the function of the peripheral IC is limited, which should be the auxiliary device for the transceiver IC in the optical communication module.

### SUMMARY OF THE INVENTION

It is therefore an object of the present invention to make a register accessible from a peripheral IC which has conventionally no accessibility thereto.

According to the present invention, a transceiver integrated circuit includes a bus for high-order layer, a bus for peripheral IC, and a register for high-order layer. The bus for high-order layer is connected to a high-order layer. The bus for peripheral IC is connected to a peripheral integrated circuit. The content of the register for high-order layer is read by the high-order layer through the bus for high-order layer. Writing to the register for high-order layer is allowed through the bus for peripheral IC.

According to the present invention, a communication module includes the transceiver integrated circuit and the peripheral integrated circuit. An abnormality warning signal is given from the peripheral integrated circuit to the high-order layer in the case of detection of abnormality.

When abnormality is detected, the peripheral integrated circuit notifies the register for high-order layer of detection of abnormality through the bus for peripheral IC. The high-order layer reads the contents stored in the register for high-order layer through the bus for high-order layer. As a result, the high-order layer is allowed to respond to this abnormality.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a first preferred embodiment of the present invention;

FIG. 2 is an exemplary block diagram of a second preferred embodiment of the present invention;

FIG. 3 is an exemplary block diagram of a third preferred embodiment of the present invention; and

FIGS. 4A through 4F together form an exemplary timing chart of the third preferred embodiment of the present invention.

### DESCRIPTION OF THE PREFERRED EMBODIMENTS

First Preferred Embodiment

FIG. 1 is a block diagram of the first preferred embodiment of the present invention. An optical communication module 10 comprises a transceiver IC 1, and is operative to function as a communication module for 10 Gb Ethernet®.

The optical communication module 10 further comprises a transmitting laser 5 and a receiving element 6, which are used for data transmission between the optical communication module 10 and the outside through an optical cable. The transmitting laser 5 receives send data 51 from the transceiver IC 1. The receiving element 6 provides receive data 52 to the transceiver IC 1.

The optical communication module 10 also comprises a peripheral IC 2 for controlling operations of the transmitting laser 5 and the receiving element 6. The peripheral IC 2 is connected to the transceiver IC 1 through a serial bus 4 for peripheral IC. The foregoing I²C bus may be applicable as the serial bus 4, for example.

The optical communication module 10 is connected to a high-order layer circuit 21. More specifically, the transceiver IC 1 and the high-order layer circuit 21 are connected through a serial bus 3 for high-order layer. The foregoing MDIO bus may be applicable as the serial bus 3, for example. Further connection is established between the transceiver IC 1 and the high-order layer circuit 21 for transmitting and receiving communication data 11 therebetween.

The transceiver IC 1 comprises a register 15 for high-order layer including the NV register and the DOM register, and an additional register 16 including the LASI register and the VS register. Both the serial bus 3 for high-order layer and the serial bus 4 for peripheral IC are connected to the register 15 for high-order layer and to the additional register 16.

In the present invention, the register 15 for high-order layer is accessible from the serial bus 4 for peripheral IC. Therefore, when the peripheral IC 2 detects abnormality in the transmitting laser 5 or in the receiving element 6, information indicating detection of the abnormality can be written to the register 15 for high-order layer through the serial bus 4 for peripheral IC. The high-order layer circuit 21 reads the contents stored in the register 15 for high-order layer through the serial bus 3 for high-order layer. As a result, such abnormality can be handled by the high-order layer circuit 21.

By way of example, the peripheral IC 2 monitors temperature in the transmitting laser 5 or in the optical communication module 10, bias in the transmitting laser 5, bias in the receiving element 6, and power source voltage of the transmitting laser 5. Comparing cumulative driving duration and output of the transmitting laser 5, the peripheral IC 2 controls bias in the transmitting laser 5 so that the output of the transmitting laser 5 is kept at a constant level. When abnormality is detected, the peripheral IC 2 writes information to the register 15 for high-order layer (to the DOM register, for example), indicating detection of the abnormality. The high-order layer circuit 21 reads the contents of the DOM register. When it is determined that the optical communication module 10 is in an inappropriate state for maintaining its operation, the optical communication module 10 is stopped by the high-order layer circuit 21, for example.

When abnormality is detected by the peripheral IC 2, an abnormality warning signal 7b is preferably given from the peripheral IC 2 to the high-order layer circuit 21. The signal 7b triggers the high-order layer circuit 21 to read the contents of the register 15 for high-order layer through the serial bus 3 for high-order layer, whereby detection of the abnormality is notified to the high-order layer circuit 21.

When abnormality is detected in communication data in the transceiver IC 1, it may be notified to the peripheral IC 2 as an abnormality detecting information 7a. The abnormality warning signal 7b is preferably given to the high-order layer circuit 21 on detection of the abnormality by the transceiver IC 1 as well as by the peripheral IC 2.

Second Preferred Embodiment

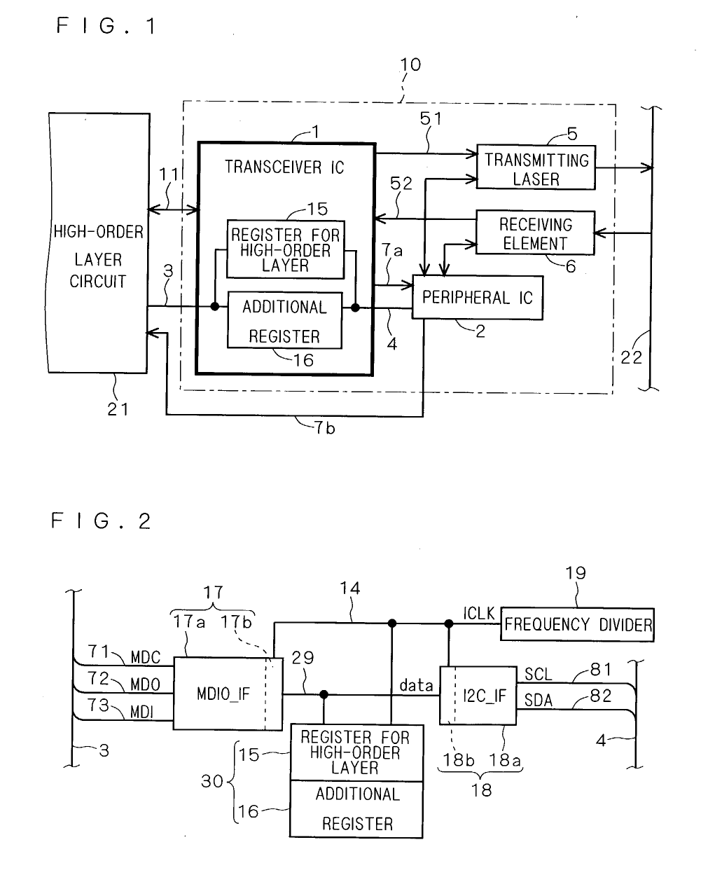

FIG. 2 is an exemplary block diagram of the second preferred embodiment of the present invention showing the internal configuration of the transceiver IC 1. The transceiver IC 1 further comprises an interface 17 for high-order layer and an interface 18 for peripheral IC. By way of example, in the following description, the serial bus 3 for high-order layer is the MDIO bus, and the serial bus 4 for peripheral IC is the I²C bus. They will be denoted as MDIO bus 3 and I²C bus 4. Accompanying this, the interface 17 for high-order layer is the one for MDIO, and the interface 18 for peripheral IC is the one for I²C (respectively indicated as “MDIO_IF” and “I²C_IF” in the figures). In the foregoing, they will be denoted as MDIO interface 17 and I²C interface 18.

The MDIO interface 17 receives data (MDI) 73 inputted thereto from the outside through the MDIO bus 3, and outputs data (MDO) 72 to the outside.

The MDIO interface 17 includes an interface body 17a, and an access controller 17b for managing access to the register 15 for high-order layer and to the additional register 16. Naturally, transmission and receipt of data are performed between the interface body 17a and the access controller 17b. However, the interface body 17a and the access controller 17b operate on the basis of the respective clock signals. More particularly, the interface body 17a operates on the basis of an external clock (MDC) 71 provided thereto from the MDIO bus 3. The access controller 17b operates on the basis of an internal clock 14 provided thereto. Data transmission and receipt between the interface body 17a and the access controller 17b are performed according to the external clock 71, for example.

A serial clock 81 and serial data 82 are transmitted and received between the I²C interface 18 and the I²C bus 4. The serial clock 81 and the serial data 82 are generated by an SCL (serial clock line) and an SDA (serial data line) of the I²C bus 4, respectively.

The I²C interface 18 includes an interface body 18a, and an access controller 18b for managing access to the register 15 for high-order layer and to the additional register 16. Naturally, transmission and receipt of data are performed between the interface body 18a and the access controller 18b. However, the interface body 18a and the access controller 18b operate on the basis of the respective clock signals. More particularly, the interface body 18a operates on the basis of the serial clock 81 provided thereto from the I²C bus 4. The access controller 18b operates on the basis of the internal clock 14 provided thereto. Data transmission and receipt between the interface body 18a and the access controller 18b are performed according to the serial clock 81, for example.

In the second preferred embodiment, the register 15 for high-order layer and the additional register 16 are collectively treated as a register 30. The internal clock 14 is further provided to the register 30, and therefore, the access controllers 17b and 18b are allowed to access the register 30. Further, the register 30 is connected to the access controllers 17b and 18b through a data line 29. Therefore, data written to and read from the register 30 can be transmitted and received between the access controllers 17b and 18b through the data line 29.

The internal clock 14 is generated inside the transceiver IC 1. By way of example, the transceiver IC 1 may be provided with a frequency divider 19. A clock signal for controlling the operation of the transceiver IC 1 is divided by the frequency divider 19, and the result of which is operative to serve as the internal clock 14. The internal clock 14 is transmitted on an interconnect line ICLK.

As discussed, the internal clock 14 is provided both to the register 15 for high-order layer and to the additional register 16, and the access controllers 17b and 18b operate on the basis of the internal clock 14. As a result, the register 15 for high-order layer is also accessible from the I²C bus 4.

Third Preferred Embodiment

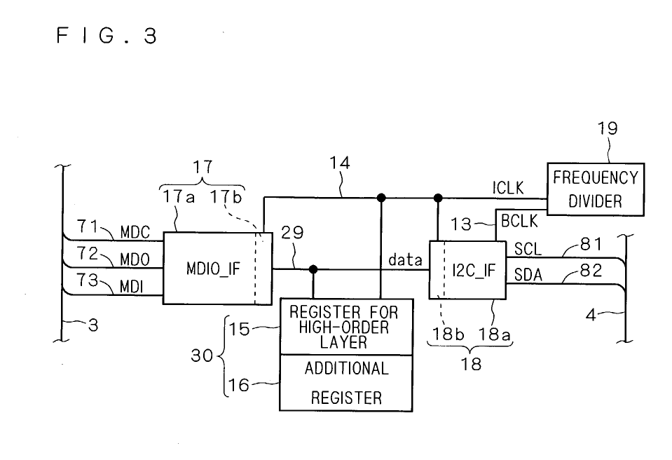

FIG. 3 is an exemplary block diagram of the third preferred embodiment of the present invention. The third preferred embodiment is different from the second preferred embodiment in that another internal clock 13 is provided from the frequency divider 19 to the interface body 18a of the I²C interface 18. The internal clock 13 is transmitted on an interconnect line BCLK.

The internal clock 13 is operative to function as a sampling clock of the serial clock 81 and the serial data 82. By way of example, the frequency of the internal clock 13 is four times the frequency of the serial clock 81. The internal clock 14 may be generated by dividing the internal clock 13.

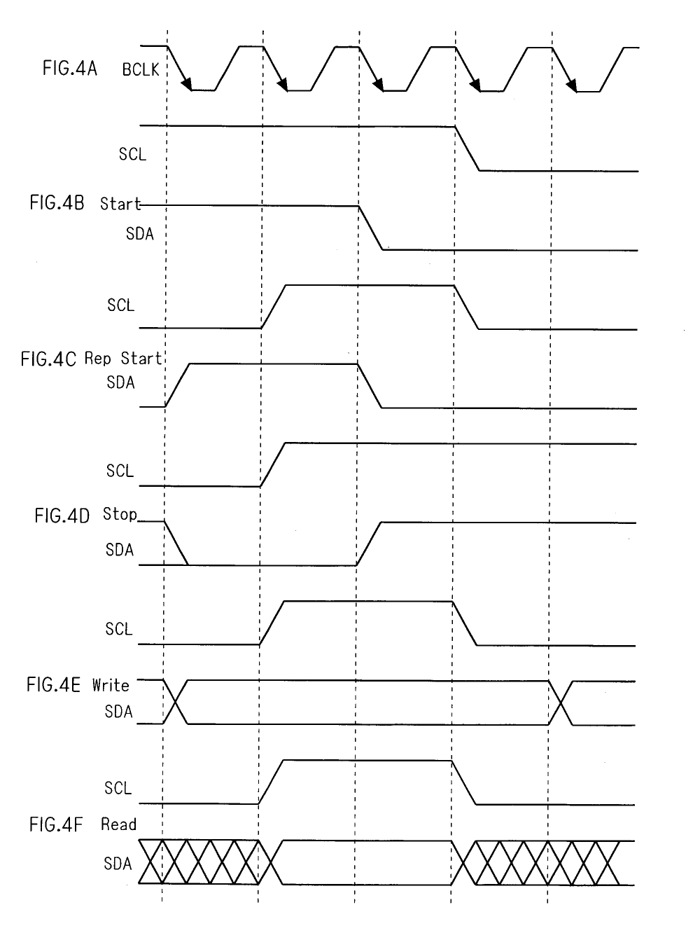

FIGS. 4A through 4F together form an exemplary timing chart showing the relation between the signal on the interconnect line BCLK (internal clock 13), signal on the SCL of the I²C bus 4 (serial clock 81) and signal on the SDA (serial data 82) of the I²C bus 4, and the operation of the I²C interface 18.

FIG. 4A is an exemplary transition diagram of the internal clock 13. At the falling edge in FIG. 4A, the serial clock 81 and the serial data 82 are sampled. FIGS. 4B through 4F show the exemplary operation of the I²C interface for which the I²C bus is generally employed. FIG. 4B provides the condition for starting data transmission. When the signal on the SCL is in “H” state, “H” to “L” transition of the signal on the SDA triggers data transmission to start. FIG. 4C provides the condition for repeated start. When the signal on the SCL is in “L” state, transition of the signal on the SDA from “L” to “H” means that data transmission is continued. Similar to the condition for starting data transmission, when the signal on the SCL is in “H” state in the subsequent period, “H” to “L” transition of the signal on the SDA triggers data transmission to restart. FIG. 4D provides the condition for stopping data transmission. When the signal on the SCL is in “H” state, “L” to “H” transition of the signal on the SDA triggers data transmission to start. FIGS. 4E and 4F respectively show writing and reading operations. For data effectiveness, the state of the signal on the SDA is arbitrarily changed when the signal on the SCL is in “L” state.

As discussed, the serial clock 81 and the serial data 82 are sampled using a sampling element higher in frequency than the serial clock 81. As a result, the serial clock 81 and the serial data 82 can be detected with a high degree of reliability. Further, the internal clock 13 as this sampling element is obtained by the frequency divider 19 which generates the internal clock 14.

In each of the foregoing first, second and third preferred embodiments, the serial bus 3 for high-order layer and the serial bus 4 for peripheral IC are respectively MDIO an I²C buses by way of example. However, the applicability of the present invention may be expanded to the alternative standard.

While the invention has been shown and described in detail, the foregoing description is in all aspects illustrative and not restrictive. It is therefore understood that numerous modifications and variations can be devised without departing from the scope of the invention.

What is claimed is:

1. A transceiver integrated circuit, comprising:
a bus for high-order layer connected to a high-order layer;
a bus for peripheral IC connected to a peripheral integrated circuit; and
a register for high-order layer, the content of which being read by said high-order layer through said bus for high-order layer, wherein
writing to said register for high-order layer is allowed through said bus for peripheral IC.

2. The transceiver integrated circuit according to claim 1, wherein
said register for high-order layer includes at least one of a non-volatile register and a digital optical monitoring register defined in XENPAK Register Set.

3. The transceiver integrated circuit according to claim 1, further comprising:
an interface for high-order layer connected to said bus for high-order layer; and
an interface for peripheral IC connected to said bus for peripheral IC, wherein
said interface for high-order layer comprises:
an interface body; and
an access controller for controlling access to said register for high-order layer,
said interface for peripheral IC comprises:
an interface body; and
an access controller for controlling access to said register for high-order layer, and
said access controller of said interface for peripheral IC, said access controller of said interface for high-order layer, and said register for high-order layer each receive a first internal clock signal given thereto.

4. The transceiver integrated circuit according to claim 3, further comprising:
a generator for generating said first internal clock signal.

5. The transceiver integrated circuit according to claim 4, wherein
said interface body of said interface for high-order layer operates on the basis of a first external clock signal given thereto through said bus for high-order layer, and
said interface body of said interface for peripheral IC operates on the basis of a second external clock signal given thereto through said bus for peripheral IC.

6. The transceiver integrated circuit according to claim 5, wherein
said bus for peripheral IC is an I²C bus, and
said second external clock signal is given from an SCL (serial clock line) of said I²C bus.

7. The transceiver integrated circuit according to claim 6, wherein
an SDA (serial data line) of said I²C bus is connected to said interface body of said interface for peripheral IC,
said second external clock signal and a signal on said SDA are sampled using a second internal clock signal higher in frequency than said second external clock signal, and
said second internal clock signal is generated inside said transceiver integrated circuit.

8. A communication module, comprising:
a transceiver integrated circuit; and
a peripheral integrated circuit, wherein
said transceiver integrated circuit comprises:
a bus for high-order layer connected to a high-order layer;
a bus for peripheral IC connected to said peripheral integrated circuit; and
a register for high-order layer, the content of which being read by said high-order layer through said bus for high-order layer,
writing to said register for high-order layer is allowed through said bus for peripheral IC, and
an abnormality warning signal is given from said peripheral integrated circuit to said high-order layer in the case of detection of abnormality.

9. The communication module according to claim 8, wherein
said register for high-order layer includes at least one of a non-volatile register and a digital optical monitoring register defined in XENPAK Register Set.

10. The communication module according to claim 8, further comprising:
an interface for high-order layer connected to said bus for high-order layer; and
an interface for peripheral IC connected to said bus for peripheral IC, wherein
said interface for high-order layer comprises:
an interface body; and
an access controller for controlling access to said register for high-order layer,
said interface for peripheral IC comprises:
an interface body; and
an access controller for controlling access to said register for high-order layer, and
said access controller of said interface for peripheral IC, said access controller of said interface for high-order layer, and said register for high-order layer each receive a first internal clock signal given thereto.

11. The communication module according to claim 10, further comprising:
a generator for generating said first internal clock signal.

12. The communication module according to claim 11, wherein
said interface body of said interface for high-order layer operates on the basis of a first external clock signal given thereto through said bus for high-order layer, and
said interface body of said interface for peripheral IC operates on the basis of a second external clock signal given thereto through said bus for peripheral IC.

13. The communication module according to claim 12, wherein
said bus for peripheral IC is an I²C bus, and
said second external clock signal is given from an SCL (serial clock line) of said I²C bus.

14. The communication module according to claim 13, wherein
an SDA (serial data line) of said I²C bus is connected to said interface body of said interface for peripheral IC,
said second external clock signal and a signal on said SDA are sampled using a second internal clock signal higher in frequency than said second external clock signal, and
said second internal clock signal is generated inside said communication module.

15. The communication module according to claim 8, further comprising:
a transmitting and receiving unit, wherein
said abnormality warning signal is given from said peripheral integrated circuit to said high-order layer in the case of detection of abnormality in said transmitting and receiving unit.

16. The communication module according to claim 15, wherein
abnormality in communication data is transmitted from said transceiver integrated circuit to said peripheral integrated circuit, and
said abnormality warning signal is further given from said peripheral integrated circuit to said high-order layer in the case of detection of abnormality in said communication data.
